(19) United States
(12) Patent Application Publication
(10) Pub. No.: US 2017/0327431 A1
(43) Pub. Date: Nov. 16, 2017

(54) FISH BY-PRODUCT BASED ORGANIC FERTILIZER

(71) Applicant: True Organic Products, Inc., Helm, CA (US)

(72) Inventor: Jacob Matthew Evans, Pebble Beach, CA (US)

(73) Assignee: True Organic Products, Inc., Helm, CA (US)

(21) Appl. No.: 15/152,330

(22) Filed: May 11, 2016

(51) Int. Cl. C05F 1/00; C05C 11/00; C05B 17/00

(52) U.S. Cl. CPC C05F 1/002; C05B 17/00; C05C 11/00

(57) ABSTRACT

A process for production of fish by-product based organic fertilizer includes combining one or more fish by-products and one or more additives, including corn steep liquor; concentrated separator by-product; and/or betaine to create a combination of one or more fish by-products and one or more additives. The combination of one or more fish by-products and one or more additives yields the fish by-product based organic fertilizer product.

### BACKGROUND

Over the years, a number of different types of fertilizer compositions have been developed and employed in agriculture. In the recent past, synthetic chemical fertilizer compositions dominated the fertilizer marketplace. More recently, however, the public has become increasingly aware and concerned about the links between synthetic chemical fertilizer use, environmental degradation, and human illness. For instance, the public has recently become more aware that synthetic chemical fertilizers contain poisons, pollute water, destroy microbes in the soil, lose half their value due to runoff, burn roots, require significant amounts of water, contain less micro-nutrition, and are heavily laden with salt.

Consequently, there has been a significant movement toward fertilizer compositions that are suitable for use in United States Department of Agriculture certified organic crop production. These fertilizer compositions are typically derived from natural sources and do not rely on synthetic chemicals. Unlike synthetic products, organic fertilizers encourage the growth of micro-organisms, which break down old plant material and convert nutrients into food. Consequently, over time, the use of organic fertilizers results in healthier and more fertile soil, which leads to hardier and more robust plants.

Furthermore, consumers are more concerned about health and the environment than ever before and are making purchasing decisions based upon those concerns. As a result, more and more consumers are purchasing organic foods. Studies show that many consumers who purchase organic foods do so because they wish to avoid toxic and persistent pesticides and fertilizers.

Due to the increased demand for organic fertilizer compositions, there is significant interest in developing better organic fertilizer compositions that provide nutrients and reduce the risk of introducing pathogens into the food supply.

Desirable nutrients include, but are not limited to, bioavailable phosphorous, potassium, and nitrogen. These nutrients must not only be present in the fertilizer, but also must be present in sufficient concentrations to benefit agricultural vegetation. In addition, the organic fertilizer compositions must be in a form that is readily applied to the agricultural vegetation and/or has minimum impact on the surrounding community. To this end, the desirable characteristics of organic fertilizer compositions include, but are not limited to, the following: the ability to directly apply the organic fertilizer compositions in a low viscosity liquid form; the ability to inject and/or add the organic fertilizer compositions into irrigation streams; time-released nitrogen components, which become bioavailable to agricultural vegetation by beneficial microbial digestion in soil; minimized chemical crop burning; minimal odor associated with the organic fertilizer composition during and/or after application; and minimized undesirable runoff.

There is a current need for an environmentally benign fertilizer derived from a natural organic source that provides sufficient levels of usable nutrients but does not require significant processing and does not raise environmental concerns.

### SUMMARY

In accordance with one embodiment, a process of manufacturing a fish by-product based organic fertilizer product is disclosed.

The Inventor developed the embodiments disclosed herein after experimenting with various fish by-products including enzyme digested fish, fish soluble by-product, and/or any other liquid one or more fish by-products, and/or any solid and/or semi-solid one or more fish by-products, and/or any liquid, semi-solid, or solid including fish and/or fish waste materials, as discussed herein, and/or as known in the art at the time of filing, and/or as developed after the time of filing.

Enzyme digested fish, also known as fish hydrolysate or “liquid fish” is created by adding an enzyme that virtually “dissolves” one or more fish by-products into an enzyme digested fish solution.

Another by-product of fish processing, fish soluble by-product, is produced when whole fish and fish waste, including fish renderings, fish offal, and spoiled fish, is heated and pressed to remove liquid. After oil is extracted from the waste and some liquid is evaporated, the waste is optionally treated with acid to stabilize the compounds it contains. The resulting product is one example of fish soluble by-product. Fish soluble by-product has been historically disfavored by the fertilizer industry because of its smell and thickness. Yet, the Inventor has discovered that when produced using the processes detailed in this disclosure, fertilizers from fish soluble by-product do not have as strong of an odor as is typical and are of an appropriate viscosity for effective application.

Fish by-products can be sourced from the waste that results from various fish processing industries such as fish canning, fish oil production, and fish meal industries. As waste materials, fish by-products are readily available.

In accordance with one embodiment, a process for production of a fish by-product based organic fertilizer includes combining one or more fish by-products and one or more additives. In one embodiment, one or more fish by-products are obtained.

In one embodiment, one or more additives are obtained. In various embodiments, the one or more additives include, but are not limited to, one or more of grain by-products, concentrated separator by-product, and betaine. In one embodiment, grain by-products include corn steep liquor, a readily available by-product of corn wet-milling. Concentrated separator by-product is a by-product of the de-sugaring of beet molasses and is therefore typically readily available. Betaine is a readily available by-product of the de-sugaring of beet molasses.

In one embodiment, the one or more fish by-products and the one or more additives are combined to yield the fish by-product based organic fertilizer product. In one embodiment, the one or more fish by-products is combined with the one or more additives such that the resulting combination of one or more fish by-products and one or more additives is 10 percent to 90 percent one or more fish by-products. In one embodiment, the one or more fish by-products is combined with the one or more additives such that the resulting combination of one or more fish by-products and one or more additives is 10 percent to 90 percent one or more additives. In other embodiments, the one or more fish by-products is combined with one or more additives such that the resulting combination of one or more fish by-products and one or more additives is any desired percentage concentration of one or more fish by-products and one or more additives.

In one embodiment, the combination of one or more fish by-products and one or more additives is filtered to remove suspended particulate matter. In one embodiment, filtration is provided using a wire mesh size in a range of 50 to 200.

In one embodiment, the combination of one or more fish by-products and one or more additives is aerated.

In one embodiment, the combination of one or more fish by-products and one or more additives is heat-treated. In one embodiment, the combination of one or more fish by-products and one or more additives is heat-treated and, in one embodiment, optionally filtered to remove suspended particulate matter.

In one embodiment, the heat-treatment is performed in a range of about 130 to 200 degrees Fahrenheit (F) for up to 15 days.

In one embodiment, the heat-treated combination of one or more fish by-products and one or more additives is cooled to yield the fish by-product based organic fertilizer product.

In one embodiment, the heat-treated combination of one or more fish by-products and one or more additives is filtered pre- and/or post-cooling. In one embodiment, filtration is provided using a wire mesh size in a range of 50 to 200.

In one embodiment, the fish by-product based organic fertilizer product is applied to fields of agricultural vegetation in quantities in the approximate range of 5 to 900 gallons per acre. In one embodiment, the fish by-product based organic fertilizer product disclosed herein is applied to the fields of agricultural vegetation either directly or by inclusion in an irrigation stream.

Using the process for production of a fish by-product based organic fertilizer product disclosed herein, a fish by-product based organic fertilizer product is provided that is environmentally benign; is non-pathogenic; is derived from a natural organic source; does not require significant processing; has minimal odor; has a low viscosity liquid form; can be applied directly to agricultural vegetation; can be injected and/or added into irrigation streams; includes time-released nitrogen components which become bioavailable to agricultural vegetation by beneficial microbial digestion in soil; and eliminates chemical crop burning.

As discussed in more detail below, using the below embodiments, with little or no modification and/or user input, there is considerable flexibility, adaptability, and opportunity for customization to meet the specific needs of various users under numerous circumstances.

### BRIEF DESCRIPTION OF THE DRAWINGS

FIG. 1 is a flow chart of a process for organic fertilization using a fish by-product based organic fertilizer product, in accordance with one embodiment;

FIG. 2 is a flow chart of a process for creating a fish by-product based organic fertilizer product from one or more fish by-products and one or more additives, in accordance with one embodiment;

FIG. 3 is a flow chart of a process for creating a fish by-product based organic fertilizer product from one or more fish by-products and corn steep liquor, in accordance with one embodiment;

FIG. 4 is a flow chart of a process for creating a fish by-product based organic fertilizer product from one or more fish by-products and concentrated separator by-product, in accordance with one embodiment; and

FIG. 5 is a flow chart of a process for creating a fish by-product based organic fertilizer product from one or more fish by-products and betaine, in accordance with one embodiment.

Common reference numerals are used throughout the figures and the detailed description to indicate like elements. One skilled in the art will readily recognize that the above figures are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying figures, which depict exemplary embodiments. Embodiments may be embodied in many different forms and should not be construed as limited to the embodiments set forth herein, shown in the figures, and/or described below. Rather, these exemplary embodiments are provided to allow a complete disclosure that conveys the principles of the invention, as set forth in the claims, to those of skill in the art.

In accordance with one embodiment, a process for organic fertilization using one or more fish by-products includes creating a fish by-product based organic fertilizer product and applying the fish by-product based organic fertilizer product to agricultural vegetation and/or the fields/soil/substrate supporting the agricultural vegetation as a method of organic fertilization of the agricultural vegetation.

As used herein, the term “fish by-product” includes raw and processed fish, fish parts, and/or fish waste including, but not limited to, enzyme digested fish, fish hydrolysate, liquid fish, fish soluble by-product, fish emulsion, fish meal, acidulated fish solubles, acidulated fish solubles stabilized with phosphoric acid, acidulated fish tankage, seafood waste, stabilized fish by-product, and/or any other fish by-product as known in the art at the time of filing or developed thereafter.

The term “additive” includes grain by-products, including corn steep liquor; concentrated separator by-product; betaine; alfalfa meal; compost; cottonseed meal; kelp and/or seaweed meal; soybean meal; humus; manure; guano; feather meal; blood meal; bone meal; Chilean nitrate of soda; Epsom salt, greensand; gypsum; hard-rock phosphate; soft-rock phosphate; limestone; and/or any other additives as known in the art at the time of filing and/or as developed after the time of filing. These additives represent significant contributions of nutrients including macronutrients nitrogen, phosphorus, and potassium. In fertilizers, an NPK value represents the relative content of the elements nitrogen, phosphorus, and potassium in a substance. In some instances, it is useful to alter an NPK value to change the ratio or amount of nutrients present in a fertilizer. The combination of one or more additives with one or more fish by-products allows for the alteration of the ratio or amount of nutrients in a fish by-product based organic fertilizer.

The term “grain by-product” includes by-products of grain processing including corn steep liquor, wet distillers grains, dried distillers grains with solubles, fermented grain solubles, corn condensed distillers solubles, and/or any other grain by-product as defined herein, known in the art at the time of filing, or developed thereafter. Corn steep liquor is a by-product of corn wet-milling and is readily available from corn processing activities, such as ethanol production. Comprised of soluble components of corn endosperm, corn steep liquor is relatively high in nutrients required for desirable plant growth, but has historically been used for livestock feed. The term corn steep liquor includes, but is not limited to, corn steepwater, light steepwater, heavy steepwater, and condensed fermented corn extractives.

The term concentrated separator by-product includes a by-product of the de-sugaring of beet molasses. As a result of this de-sugaring, proteins and minerals in the beet molasses are concentrated to form concentrated separator by-product, which is commonly used as livestock feed. The present Inventor discovered that, contrary to conventional wisdom and practice in the art, heat-treating concentrated separator by-product denatures the heat labile vegetable proteins contained in the concentrated separator by-product sufficiently to allow additional nitrogen to become bioavailable. See Evans, U.S. Pat. No. 7,927,397. Likewise, phosphorous apparently becomes more available as vegetative nucleosides are broken down by both the original de-sugaring process and the added heat-treatment process.

To his surprise, the present Inventor discovered that the heat-treatment of concentrated separator by-product resulted in a concentrated separator by-product based fertilizer product having significantly increased bioavailable nitrogen, potassium and phosphorous in a readily pumpable, or low viscosity, fluid state.

The term betaine includes an N-trimethylated amino acid produced as a by-product of de-sugaring beet molasses. Betaine has been historically used as a feed additive for many animal species. Despite being readily available, betaine was not considered an economically viable fertilizer component by traditional agricultural teachings because of its initial expense, its relatively small percentage of available nitrogen, and the belief that betaine could not satisfy the USDA National Organic Program regulations to be an organic fertilizer nutrient.

According to this long-standing teaching in the art, the use of betaine as a fertilizer was prohibitively expensive and it was considered more cost effective for a user seeking fertilizer to purchase urea, which contains a higher percentage of nitrogen than betaine, than to purchase betaine. Consequently, given the expense of betaine and its relatively small percentage of nitrogen, traditional agriculture largely ignored betaine as a viable fertilizer. However, as a result of extensive research and experimentation, the Inventor discovered the unexpected result that properly processed, betaine can meet the USDA National Organic Program standards set forth below, and can therefore be used as an organic fertilizer. Once the Inventor realized that betaine can be processed to meet the USDA National Organic Program standards for an organic fertilizer, the Inventor realized that betaine has a special use and special value as an organic nitrogen source and that this discovered property more than justifies its expense.

As used herein, the term “organic fertilizer” means an ingredient or product that may be used in certified organic crop production in accordance with USDA National Organic Program standards.

Currently, 7 CFR 205.203 provides the practice standard for certified organic crop production. The regulations under 7 CFR 205.203 provide the following:

(a) The producer must select and implement tillage and cultivation practices that maintain or improve the physical, chemical, and biological condition of soil and minimize soil erosion.

(b) The producer must manage crop nutrients and soil fertility through rotations, cover crops, and the application of plant and animal materials.

(c) The producer must manage plant and animal materials to maintain or improve soil organic matter content in a manner that does not contribute to contamination of crops, soil, or water by plant nutrients, pathogenic organisms, heavy metals, or residues of prohibited substances. Animal and plant materials include:

(1) Raw animal manure, which must be composted unless it is:
(i) Applied to land used for a crop not intended for human consumption;
(ii) Incorporated into the soil not less than 120 days prior to the harvest of a product whose edible portion has direct contact with the soil surface or soil particles; or
(iii) Incorporated into the soil not less than 90 days prior to the harvest of a product whose edible portion does not have direct contact with the soil surface or soil particles;

(2) Composted plant and animal materials produced through a process that:
(i) Established an initial C:N ratio of between 25:1 and 40:1; and
(ii) Maintained a temperature of between 131° F. and 170° F. for 3 days using an in-vessel or static aerated pile system; or
(iii) Maintained a temperature of between 131° F. and 170° F. for 15 days using a windrow composting system, during which period, the materials must be turned a minimum of five times.

(3) Uncomposted Plant Materials.

(d) A producer may manage crop nutrients and soil fertility to maintain or improve soil organic matter content in a manner that does not contribute to contamination of crops, soil, or water by plant nutrients, pathogenic organisms, heavy metals, or residues of prohibited substances by applying:
(1) A crop nutrient or soil amendment included on the National List of synthetic substances allowed for use in organic crop production;
(2) A mined substance of low solubility;
(3) A mined substance of high solubility: Provided, That, the substance is used in compliance with the conditions established on the National List of nonsynthetic materials prohibited for crop production;
(4) Ash obtained from the burning of a plant or animal material, except as prohibited in paragraph (e) of this section: Provided, That, the material burned has not been treated or combined with a prohibited substance or the ash is not included on the National List of nonsynthetic substances prohibited for use in organic crop production; and
(5) A plant or animal material that has been chemically altered by a manufacturing process: Provided, that, the material is included on the National List of synthetic substances allowed for use in organic crop production established in §205.601.

(e) The producer must not use:
(1) Any fertilizer or composted plant and animal material that contains a synthetic substance not included on the National List of synthetic substances allowed for use in organic crop production;
(2) Sewage sludge (biosolids) as defined in 40 CFR part 503; and (3) Burning as a means of disposal for crop residues produced on the operation: Except, That, burning may be used to suppress the spread of disease or to stimulate seed germination.

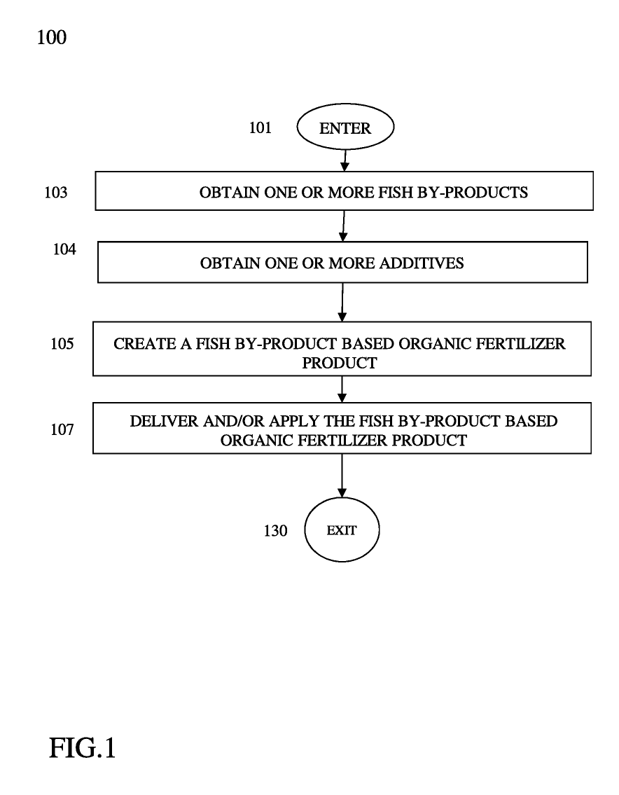

FIG. 1 shows a flow chart of a process for organic fertilization of agricultural vegetation using fish by-product based organic fertilizer 100 in accordance with one embodiment. As shown in FIG. 1, the process for organic fertilization of agricultural vegetation using fish by-product based organic fertilizer 100 begins at ENTER OPERATION 101 and process flow proceeds to OBTAIN ONE OR MORE FISH BY-PRODUCTS OPERATION 103.

In one embodiment, at OBTAIN ONE OR MORE FISH BY-PRODUCTS OPERATION 103, a quantity of one or more fish by-products is obtained.

In one embodiment, once a quantity of one or more fish by-products is obtained at OBTAIN ONE OR MORE FISH BY-PRODUCTS OPERATION 103, process flow proceeds to OBTAIN ONE OR MORE ADDITIVES OPERATION 104.

In one embodiment, at OBTAIN ONE OR MORE ADDITIVES OPERATION 104, a quantity of one or more additives is obtained. In various embodiments, the one or more additives include one or more of corn steep liquor, concentrated separator by-product, and betaine.

In one embodiment, once a quantity of one or more additives is obtained at OBTAIN ONE OR MORE ADDITIVES OPERATION 104, process flow proceeds to CREATE A FISH BY-PRODUCT BASED ORGANIC FERTILIZER PRODUCT OPERATION 105.

In one embodiment, at CREATE A FISH BY-PRODUCT BASED ORGANIC FERTILIZER PRODUCT OPERATION 105, a fish by-product based organic fertilizer product is created. In various embodiments, a fish by-product based organic fertilizer is created by combining the one or more fish by-products of OBTAIN ONE OR MORE FISH BY-PRODUCTS OPERATION 103 and the one or more additives of OBTAIN ONE OR MORE ADDITIVES OPERATION 104 to yield the fish by-product based organic fertilizer product. In one embodiment, a fish by-product based organic fertilizer is created by combining the one or more fish by-products of OBTAIN ONE OR MORE FISH BY-PRODUCTS OPERATION 103 and the one or more additives of OBTAIN ONE OR MORE ADDITIVES OPERATION 104 to create a combination of one or more fish by-products and one or more additives; heat-treating the combination of one or more fish by-products and one or more additives; and cooling the heat-treated combination of one or more fish by-products and one or more additives to yield the fish by-product based organic fertilizer product.

In one embodiment, once a fish by-product based organic fertilizer product is created at CREATE A FISH BY-PRODUCT BASED ORGANIC FERTILIZER PRODUCT OPERATION 105, process flow proceeds to DELIVER AND/OR APPLY THE FISH BY-PRODUCT BASED ORGANIC FERTILIZER PRODUCT OPERATION 107.

In one embodiment, at DELIVER AND/OR APPLY THE FISH BY-PRODUCT BASED ORGANIC FERTILIZER PRODUCT OPERATION 107, the fish by-product based organic fertilizer product of CREATE A FISH BY-PRODUCT BASED ORGANIC FERTILIZER PRODUCT OPERATION 105 is transferred in bulk to a tanker truck and/or disposed into drums for delivery of smaller quantities of the fish by-product based organic fertilizer product. In one embodiment, at DELIVER AND/OR APPLY THE FISH BY-PRODUCT BASED ORGANIC FERTILIZER PRODUCT OPERATION 107, the fish by-product based organic fertilizer product of CREATE A FISH BY-PRODUCT BASED ORGANIC FERTILIZER PRODUCT OPERATION 105 is then delivered to farms for application to agricultural vegetation.

In one embodiment, at DELIVER AND/OR APPLY THE FISH BY-PRODUCT BASED ORGANIC FERTILIZER PRODUCT OPERATION 107, a quantity of the fish by-product based organic fertilizer product of CREATE A FISH BY-PRODUCT BASED ORGANIC FERTILIZER PRODUCT OPERATION 105 is offloaded into plastic field tanks located at or near the application site. In one embodiment, at DELIVER AND/OR APPLY THE FISH BY-PRODUCT BASED ORGANIC FERTILIZER PRODUCT OPERATION 107, the plastic field tanks are then used to feed the fish by-product based organic fertilizer product of CREATE A FISH BY-PRODUCT BASED ORGANIC FERTILIZER PRODUCT OPERATION 105 into an irrigation stream either by direct injection or by vacuum drawing from the irrigation flow.

Depending on the particular agricultural vegetation requirements, the application rate of the fish by-product based organic fertilizer product of CREATE A FISH BY-PRODUCT BASED ORGANIC FERTILIZER PRODUCT OPERATION 105 at DELIVER AND/OR APPLY THE FISH BY-PRODUCT BASED ORGANIC FERTILIZER PRODUCT OPERATION 107 may be anywhere in a range of approximately 5 to 900 gallons per acre.

In one embodiment, at DELIVER AND/OR APPLY THE FISH BY-PRODUCT BASED ORGANIC FERTILIZER PRODUCT OPERATION 107 the fish by-product based organic fertilizer product of CREATE A FISH BY-PRODUCT BASED ORGANIC FERTILIZER PRODUCT OPERATION 105 may also be directly sprayed onto the agricultural vegetation without concerns of plant burning as may occur with more concentrated inorganic fertilizers.

In one embodiment, once the fish by-product based organic fertilizer product of CREATE A FISH BY-PRODUCT BASED ORGANIC FERTILIZER PRODUCT OPERATION 105 is delivered and applied at DELIVER AND/OR APPLY THE FISH BY-PRODUCT BASED ORGANIC FERTILIZER PRODUCT OPERATION 107, process flow proceeds to EXIT OPERATION 130 and the process for organic fertilization of agricultural vegetation using one or more fish by-products 100 is exited.

Using the process for organic fertilization of agricultural vegetation using one or more fish by-products 100, a fish by-product based organic fertilizer product is provided that is environmentally benign; is non-pathogenic; is derived from natural organic sources; does not require significant processing; has minimal odor; has a low viscosity liquid form; can be applied directly to agricultural vegetation; can be injected and/or added into irrigation streams; includes time-released nitrogen components which become bioavailable to agricultural vegetation by beneficial microbial digestion in soil; and eliminates chemical crop burning.

In accordance with one embodiment, a process for production of a fish by-product based organic fertilizer product includes combining one or more fish by-products with one or more additives. In one embodiment, the combination of one or more fish by-products and one or more additives is then heat-treated and, in one embodiment, optionally filtered to remove suspended particulate matter. In one embodiment, the heat-treated combination of one or more fish by-products and one or more additives is then cooled to yield the fish by-product based organic fertilizer product. In one embodiment, the fish by-product based organic fertilizer product is then applied to agricultural vegetation, either directly or by inclusion in an irrigation stream.

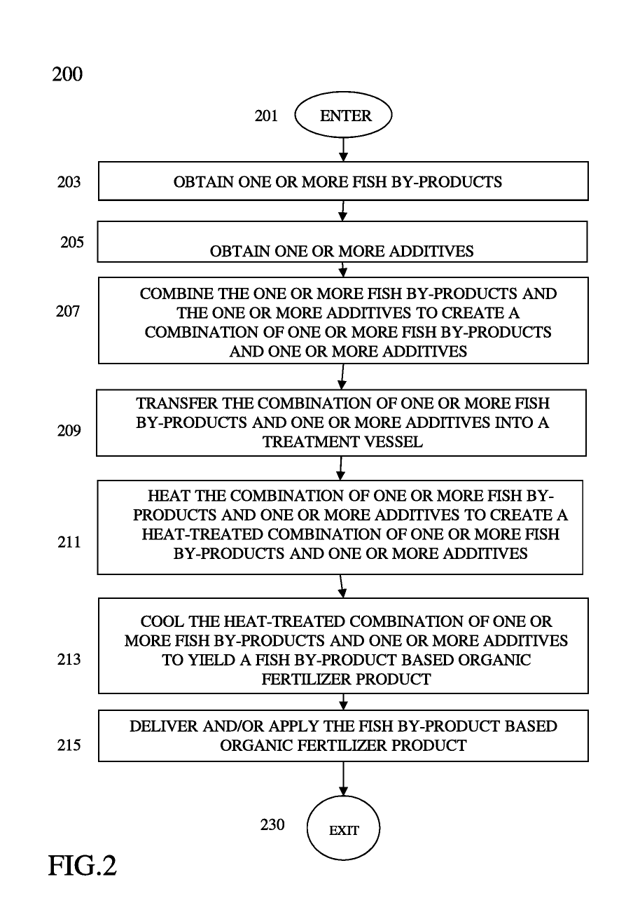

FIG. 2 is a flow chart of a process for creating a fish by-product based organic fertilizer product from one or more fish by-products and one or more additives, in accordance with one embodiment. As shown in FIG. 2, a process for production of a fish by-product based organic fertilizer product from one or more fish by-products and one or more additives 200 begins at ENTER OPERATION 201 and process flow proceeds to OBTAIN ONE OR MORE FISH BY-PRODUCTS OPERATION 203.

The one or more fish by-products of OBTAIN ONE OR MORE FISH BY-PRODUCTS OPERATION 203 are, in various embodiments, waste products from fish processing. In one embodiment, once the one or more fish by-products are obtained at OBTAIN ONE OR MORE FISH BY-PRODUCTS OPERATION 203, process flow proceeds to OBTAIN ONE OR MORE ADDITIVES OPERATION 205.

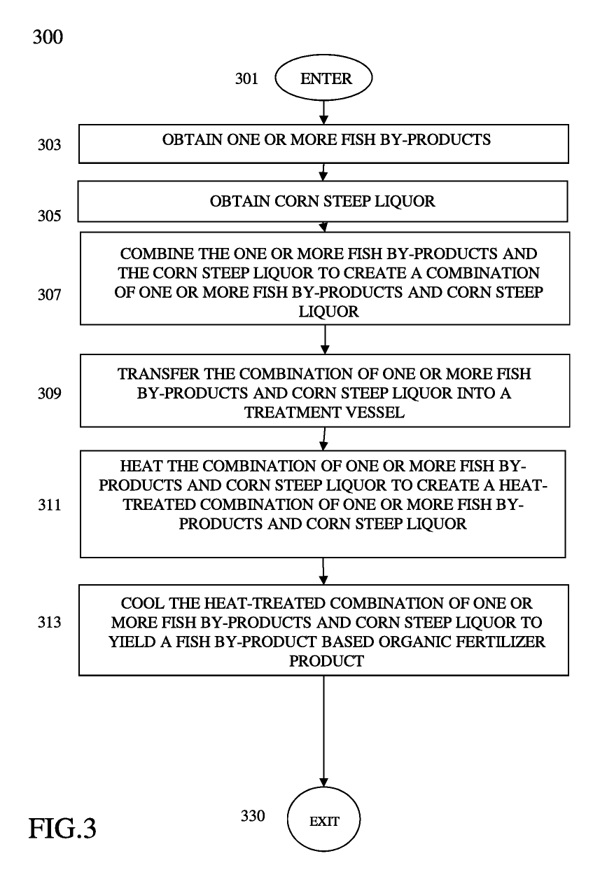

The one or more additives of OBTAIN ONE OR MORE ADDITIVES OPERATION 205 include, but are not limited to, one or more of the following: grain by-products, including corn steep liquor; concentrated separator by-product; betaine; and/or any other additive as known in the industry at or after the time of filing. For example, in one embodiment, the one or more additives include corn steep liquor. In one embodiment, the one or more additives include concentrated separator by-product. In one embodiment, the one or more additives include betaine. In one embodiment, the one or more additives include corn steep liquor and betaine. In one embodiment, the one or more additives include corn steep liquor and concentrated separator by-product. In one embodiment, the one or more additives include betaine and concentrated separator by-product. In one embodiment, the one or more additives include corn steep liquor, concentrated separator by-product, and betaine. Corn steep liquor, concentrated separator by-product, and betaine are each discussed in more detail in FIGS. 3, 4, and 5, respectively.

After one or more additives are obtained at OBTAIN ONE OR MORE ADDITIVES OPERATION 205, process flow proceeds to COMBINE THE ONE OR MORE FISH BY-PRODUCTS AND THE ONE OR MORE ADDITIVES TO CREATE A COMBINATION OF ONE OR MORE FISH BY-PRODUCTS AND ONE OR MORE ADDITIVES OPERATION 207, in one embodiment. According to one embodiment, at COMBINE THE ONE OR MORE FISH BY-PRODUCTS AND THE ONE OR MORE ADDITIVES TO CREATE A COMBINATION OF ONE OR MORE FISH BY-PRODUCTS AND ONE OR MORE ADDITIVES OPERATION 207, at least a portion of the obtained one or more fish by-products and at least a portion of the obtained one or more additives are combined.

In one embodiment, the one or more fish by-products is combined with the one or more additives such that the resulting combination of one or more fish by-products and one or more additives is 10 percent to 90 percent one or more fish by-products. In one embodiment, the one or more fish by-products are combined with the one or more additives such that the resulting combination of one or more fish by-products and one or more additives is 10 percent to 90 percent additives.

In other embodiments, at COMBINE THE ONE OR MORE FISH BY-PRODUCTS AND THE ONE OR MORE ADDITIVES TO CREATE A COMBINATION OF ONE OR MORE FISH BY-PRODUCTS AND ONE OR MORE ADDITIVES OPERATION 207, the one or more fish by-products is combined with the one or more additives such that the resulting combination of one or more fish by-products and one or more additives is any desired percentage concentration of one or more fish by-products and one or more additives, typically as determined by cost and the specific needs of the user.

In one embodiment, once the one or more fish by-products is combined with the one or more additives at COMBINE THE ONE OR MORE FISH BY-PRODUCTS AND THE ONE OR MORE ADDITIVES TO CREATE A COMBINATION OF ONE OR MORE FISH BY-PRODUCTS AND ONE OR MORE ADDITIVES OPERATION 207 to yield the fish by-product based organic fertilizer product, process flow proceeds to DELIVER AND/OR APPLY THE FISH BY-PRODUCT BASED ORGANIC FERTILIZER PRODUCT OPERATION 215.

In one embodiment, once the one or more fish by-products and one or more additives are combined at COMBINE THE ONE OR MORE FISH BY-PRODUCTS AND THE ONE OR MORE ADDITIVES TO CREATE A COMBINATION OF ONE OR MORE FISH BY-PRODUCTS AND ONE OR MORE ADDITIVES OPERATION 207, process flow proceeds to TRANSFER THE COMBINATION OF ONE OR MORE FISH BY-PRODUCTS AND ONE OR MORE ADDITIVES INTO A TREATMENT VESSEL OPERATION 209.

In various embodiments, at TRANSFER THE COMBINATION OF ONE OR MORE FISH BY-PRODUCTS AND ONE OR MORE ADDITIVES INTO A TREATMENT VESSEL OPERATION 209, at least a portion of the combination of one or more fish by-products and one or more additives is transferred into one or more treatment vessels.

In one embodiment, at TRANSFER THE COMBINATION OF ONE OR MORE FISH BY-PRODUCTS AND ONE OR MORE ADDITIVES INTO A TREATMENT VESSEL OPERATION 209, the combination of one or more fish by-products and one or more additives is filtered as the combination of one or more fish by-products and one or more additives is disposed into the treatment vessel. In one embodiment, this filtering is optional. For example, the combination of one or more fish by-products and one or more additives may not be filtered if the amount of suspended particulate matter is minimal. If pre-treatment filtration is desired, a stainless steel, or other suitable material, mesh having a mesh size number between 50 and 200 may be employed. In one embodiment, the mesh size is 200.

In one embodiment, once at least a portion of the combination of one or more fish by-products and one or more additives is placed in one or more treatment vessels at TRANSFER THE COMBINATION OF ONE OR MORE FISH BY-PRODUCTS AND ONE OR MORE ADDITIVES INTO A TREATMENT VESSEL OPERATION 209, process flow proceeds to HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211.

In one embodiment, at HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211, at least a portion of the combination of one or more fish by-products and one or more additives of COMBINE THE ONE OR MORE FISH BY-PRODUCTS AND THE ONE OR MORE ADDITIVES TO CREATE A COMBINATION OF ONE OR MORE FISH BY-PRODUCTS AND ONE OR MORE ADDITIVES OPERATION 207 is mechanically heated.

In one embodiment, at HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211, heat is optionally applied to the combination of one or more fish by-products and one or more additives to raise the average temperature of the combination of one or more fish by-products and one or more additives to at least 130 degrees F. This temperature range is known to inhibit pathogenic bacterial growth of the most common pathogens such as Escherichia coli O157:H7 and Salmonella.

In one embodiment, at HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211, the combination of one or more fish by-products and one or more additives is maintained in the treatment vessel at or above 130 degrees F. for up to 4 hours. In one embodiment, at HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211, the combination of one or more fish by-products and one or more additives is maintained in the treatment vessel at or above 130 degrees F. for at least 4 hours. In one embodiment, at HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211, the combination of one or more fish by-products and one or more additives is maintained in the treatment vessel at or above 130 degrees F. for at least 24 hours to ensure uniform heat transfer to the combination of one or more fish by-products and one or more additives. In one embodiment, filtration may be accomplished concurrently at HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211. In one embodiment, the heat-treatment of HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211 may be performed for 120 hours or more, if desired.

In one embodiment, water and/or other liquid may be blended with the combination of one or more fish by-products and one or more additives at HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211 to meet the desired nitrogen per weight or volume requirements of the combination of one or more fish by-products and one or more additives. In one embodiment, water and/or other liquid may also be used to recover losses due to evaporation during the heat-treatment process of HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211. Liquid blending is typically not required, but is rather an optional procedure.

In one embodiment, once at least a portion of the combination of one or more fish by-products and one or more additives of COMBINE THE ONE OR MORE FISH BY-PRODUCTS AND THE ONE OR MORE ADDITIVES TO CREATE A COMBINATION OF ONE OR MORE FISH BY-PRODUCTS AND ONE OR MORE ADDITIVES OPERATION 207 is heat-treated in the treatment vessel of TRANSFER THE COMBINATION OF ONE OR MORE FISH BY-PRODUCTS AND ONE OR MORE ADDITIVES INTO A TREATMENT VESSEL OPERATION 209 at HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211 to create a heat-treated combination of one or more fish by-products and one or more additives, process flow proceeds to COOL THE HEAT-TREATED COMBINATION OF ONE OR MORE FISH BY-PRODUCTS AND ONE OR MORE ADDITIVES TO YIELD A FISH BY-PRODUCT BASED ORGANIC FERTILIZER PRODUCT OPERATION 213.

In one embodiment, at COOL THE HEAT-TREATED COMBINATION OF ONE OR MORE FISH BY-PRODUCTS AND ONE OR MORE ADDITIVES TO YIELD A FISH BY-PRODUCT BASED ORGANIC FERTILIZER PRODUCT OPERATION 213, the heat-treated combination of one or more fish by-products and one or more additives of HEAT THE COMBINATION OF ONE OR MORE FISH BY-PRODUCTS AND ONE OR MORE ADDITIVES TO CREATE A HEAT-TREATED COMBINATION OF ONE OR MORE FISH BY-PRODUCTS AND ONE OR MORE ADDITIVES OPERATION 211 is allowed to cool in the treatment vessel of TRANSFER THE COMBINATION OF ONE OR MORE FISH BY-PRODUCTS AND ONE OR MORE ADDITIVES INTO A TREATMENT VESSEL OPERATION 209.

As noted, in one embodiment, the cooling at COOL THE HEAT-TREATED COMBINATION OF ONE OR MORE FISH BY-PRODUCTS AND ONE OR MORE ADDITIVES TO YIELD A FISH BY-PRODUCT BASED ORGANIC FERTILIZER PRODUCT OPERATION 213 yields the resulting fish by-product based organic fertilizer product.

In one embodiment, once the heat-treated combination of one or more fish by-products and one or more additives is cooled at COOL THE HEAT-TREATED COMBINATION OF ONE OR MORE FISH BY-PRODUCTS AND ONE OR MORE ADDITIVES TO YIELD A FISH BY-PRODUCT BASED ORGANIC FERTILIZER PRODUCT OPERATION 213 to yield the fish by-product based organic fertilizer product, process flow proceeds to DELIVER AND/OR APPLY THE FISH BY-PRODUCT BASED ORGANIC FERTILIZER PRODUCT OPERATION 215.

In one embodiment, at DELIVER AND/OR APPLY THE FISH BY-PRODUCT BASED ORGANIC FERTILIZER PRODUCT OPERATION 215 the fish by-product based organic fertilizer product is transferred in bulk to a tanker truck and/or transferred into drums for delivery of smaller quantities of the fish by-product based organic fertilizer product. In one embodiment, at DELIVER AND/OR APPLY THE FISH BY-PRODUCT BASED ORGANIC FERTILIZER PRODUCT OPERATION 215, the fish by-product based organic fertilizer product is then delivered to farms for application to agricultural vegetation.

In one embodiment, at DELIVER AND/OR APPLY THE FISH BY-PRODUCT BASED ORGANIC FERTILIZER PRODUCT OPERATION 215, a quantity of the fish by-product based organic fertilizer product is offloaded into plastic field tanks located at or near the application site. In one embodiment, at DELIVER AND/OR APPLY THE FISH BY-PRODUCT BASED ORGANIC FERTILIZER PRODUCT OPERATION 215, the plastic field tanks are then used to feed the fish by-product based organic fertilizer product into the irrigation stream either by direct injection or by vacuum drawing from the irrigation flow.

Depending on the particular agricultural vegetation requirements, the application rate of fish by-product based organic fertilizer product at DELIVER AND/OR APPLY THE FISH BY-PRODUCT BASED ORGANIC FERTILIZER PRODUCT OPERATION 215 may be anywhere in a range of approximately 5 to 900 gallons per acre.

In one embodiment, at DELIVER AND/OR APPLY THE FISH BY-PRODUCT BASED ORGANIC FERTILIZER PRODUCT OPERATION 215, the fish by-product based organic fertilizer product may also be directly sprayed onto the agricultural vegetation without concerns of plant burning as may occur with more concentrated inorganic fertilizers.

In one embodiment, once the fish by-product based organic fertilizer product is delivered and applied at DELIVER AND/OR APPLY THE FISH BY-PRODUCT BASED ORGANIC FERTILIZER PRODUCT OPERATION 215, process flow proceeds to EXIT OPERATION 230 and the process for production of a fish by-product based organic fertilizer product from one or more fish by-products and one or more additives 200 is exited.

FIG. 3 is a flow chart of a process for creating a fish by-product based organic fertilizer product from one or more fish by-products and corn steep liquor, in accordance with one embodiment. As shown in FIG. 3, a process for production of a fish by-product based organic fertilizer product from one or more fish by-products and corn steep liquor 300 begins at ENTER OPERATION 301 and process flow proceeds to OBTAIN ONE OR MORE FISH BY-PRODUCTS OPERATION 303.

The one or more fish by-products of OBTAIN ONE OR MORE FISH BY-PRODUCTS OPERATION 303 are, in various embodiments, waste products resulting from fish processing. In one embodiment, once the one or more fish by-products are obtained at OBTAIN ONE OR MORE FISH BY-PRODUCTS OPERATION 303, process flow proceeds to OBTAIN CORN STEEP LIQUOR OPERATION 305.

In one embodiment, the corn steep liquor of OBTAIN CORN STEEP LIQUOR OPERATION 305 is a by-product of corn wet-milling and is readily available from ethanol production facilities. As a valuable nitrogen source, when combined with one or more fish by-products, corn steep liquor alters the NPK value of the resulting fish by-product based organic fertilizer.

After corn steep liquor is obtained at OBTAIN CORN STEEP LIQUOR OPERATION 305, process flow proceeds to COMBINE THE ONE OR MORE FISH BY-PRODUCTS AND THE CORN STEEP LIQUOR TO CREATE A COMBINATION OF ONE OR MORE FISH BY-PRODUCTS AND CORN STEEP LIQUOR OPERATION 307, in one embodiment. According to one embodiment, at COMBINE THE ONE OR MORE FISH BY-PRODUCTS AND THE CORN STEEP LIQUOR TO CREATE A COMBINATION OF ONE OR MORE FISH BY-PRODUCTS AND CORN STEEP LIQUOR OPERATION 307, at least a portion of the obtained one or more fish by-products and at least a portion of the obtained corn steep liquor are combined.

In one embodiment, the one or more fish by-products is combined with the corn steep liquor such that the resulting combination of one or more fish by-products and corn steep liquor is 10 percent to 90 percent one or more fish by-products. In one embodiment, the one or more fish by-products is combined with the corn steep liquor such that the resulting combination of one or more fish by-products and corn steep liquor is 10 percent to 90 percent corn steep liquor.

In other embodiments, at COMBINE THE ONE OR MORE FISH BY-PRODUCTS AND THE CORN STEEP LIQUOR TO CREATE A COMBINATION OF ONE OR MORE FISH BY-PRODUCTS AND CORN STEEP LIQUOR OPERATION 307, the one or more fish by-products is combined with the corn steep liquor such that the resulting combination of one or more fish by-products and corn steep liquor is any desired percentage concentration of one or more fish by-products, typically as determined by cost and the specific needs of the user.

In one embodiment, at COMBINE THE ONE OR MORE FISH BY-PRODUCTS AND THE CORN STEEP LIQUOR TO CREATE A COMBINATION OF ONE OR MORE FISH BY-PRODUCTS AND CORN STEEP LIQUOR OPERATION 307, the one or more fish by-products is combined with the corn steep liquor to yield the fish by-product based organic fertilizer product.

In one embodiment, once the one or more fish by-products is combined with the corn steep liquor to yield the fish by-product based organic fertilizer product at COMBINE THE ONE OR MORE FISH BY-PRODUCTS AND THE CORN STEEP LIQUOR TO CREATE A COMBINATION OF ONE OR MORE FISH BY-PRODUCTS AND CORN STEEP LIQUOR OPERATION 307, process flow proceeds to EXIT OPERATION 330 and the process for production of a fish by-product based organic fertilizer product from one or more fish by-products and corn steep liquor 300 is exited.

In one embodiment, once the one or more fish by-products and corn steep liquor are combined at COMBINE THE ONE OR MORE FISH BY-PRODUCTS AND THE CORN STEEP LIQUOR TO CREATE A COMBINATION OF ONE OR MORE FISH BY-PRODUCTS AND CORN STEEP LIQUOR OPERATION 307, process flow proceeds to TRANSFER THE COMBINATION OF ONE OR MORE FISH BY-PRODUCTS AND CORN STEEP LIQUOR INTO A TREATMENT VESSEL OPERATION 309.

In various embodiments, at TRANSFER THE COMBINATION OF ONE OR MORE FISH BY-PRODUCTS AND CORN STEEP LIQUOR INTO A TREATMENT VESSEL OPERATION 309, at least a portion of the combination of one or more fish by-products and corn steep liquor is transferred into one or more treatment vessels.

In one embodiment, at TRANSFER THE COMBINATION OF ONE OR MORE FISH BY-PRODUCTS AND CORN STEEP LIQUOR INTO A TREATMENT VESSEL OPERATION 309, the combination of one or more fish by-products and corn steep liquor is filtered as the combination of one or more fish by-products and corn steep liquor is disposed into the treatment vessel. In one embodiment, this filtering is optional. If pre-treatment filtration is desired, a stainless steel, or other suitable material, mesh having a mesh size number between 50 and 200 may be employed. In one embodiment, the mesh size is 200.

In one embodiment, once at least a portion of the combination of one or more fish by-products and corn steep liquor is placed in one or more treatment vessels at TRANSFER THE COMBINATION OF ONE OR MORE FISH BY-PRODUCTS AND CORN STEEP LIQUOR INTO A TREATMENT VESSEL OPERATION 309, process flow proceeds to HEAT THE COMBINATION OF ONE OR MORE FISH BY-PRODUCTS AND CORN STEEP LIQUOR TO CREATE A HEAT-TREATED COMBINATION OF ONE OR MORE FISH BY-PRODUCTS AND CORN STEEP LIQUOR OPERATION 311.

In one embodiment, at HEAT THE COMBINATION OF ONE OR MORE FISH BY-PRODUCTS AND CORN STEEP LIQUOR TO CREATE A HEAT-TREATED COMBINATION OF ONE OR MORE FISH BY-PRODUCTS AND CORN STEEP LIQUOR OPERATION 311, at least a portion of the combination of one or more fish by-products and corn steep liquor of COMBINE THE ONE OR MORE FISH BY-PRODUCTS AND THE CORN STEEP LIQUOR TO CREATE A COMBINATION OF ONE OR MORE FISH BY-PRODUCTS AND CORN STEEP LIQUOR OPERATION 307 is mechanically heated.

In one embodiment, at HEAT THE COMBINATION OF ONE OR MORE FISH BY-PRODUCTS AND CORN STEEP LIQUOR TO CREATE A HEAT-TREATED COMBINATION OF ONE OR MORE FISH BY-PRODUCTS AND CORN STEEP LIQUOR OPERATION 311, heat is optionally applied to the combination of one or more fish by-products and corn steep liquor to raise the average temperature of the combination of one or more fish by-products and corn steep liquor to at least 130 degrees F.

In one embodiment, at HEAT THE COMBINATION OF ONE OR MORE FISH BY-PRODUCTS AND CORN STEEP LIQUOR TO CREATE A HEAT-TREATED COMBINATION OF ONE OR MORE FISH BY-PRODUCTS AND CORN STEEP LIQUOR OPERATION 311, the combination of one or more fish by-products and corn steep liquor is maintained in the treatment vessel at or above 130 degrees F. for less than 4 hours. In one embodiment, at HEAT THE COMBINATION OF ONE OR MORE FISH BY-PRODUCTS AND CORN STEEP LIQUOR TO CREATE A HEAT-TREATED COMBINATION OF ONE OR MORE FISH BY-PRODUCTS AND CORN STEEP LIQUOR OPERATION 311, the combination of one or more fish by-products and corn steep liquor is maintained in the treatment vessel at or above 130 degrees F. for at least 4 hours. In one embodiment, at HEAT THE COMBINATION OF ONE OR MORE FISH BY-PRODUCTS AND CORN STEEP LIQUOR TO CREATE A HEAT-TREATED COMBINATION OF ONE OR MORE FISH BY-PRODUCTS AND CORN STEEP LIQUOR OPERATION 311, the combination of one or more fish by-products and corn steep liquor is maintained in the treatment vessel at or above 130 degrees F. for at least 24 hours to ensure uniform heat transfer to the combination of one or more fish by-products and corn steep liquor. In one embodiment, the heat-treatment of HEAT THE COMBINATION OF ONE OR MORE FISH BY-PRODUCTS AND CORN STEEP LIQUOR TO CREATE A HEAT-TREATED COMBINATION OF ONE OR MORE FISH BY-PRODUCTS AND CORN STEEP LIQUOR OPERATION 311 may be performed for 120 hours or more, if desired.

In one embodiment, water may be blended with the combination of one or more fish by-products and corn steep liquor at HEAT THE COMBINATION OF ONE OR MORE FISH BY-PRODUCTS AND CORN STEEP LIQUOR TO CREATE A HEAT-TREATED COMBINATION OF ONE OR MORE FISH BY-PRODUCTS AND CORN STEEP LIQUOR OPERATION 311 to meet the desired nitrogen per weight or volume requirements of the combination of corn steep liquor and one or more fish by-products. In one embodiment, water may also be used to recover losses due to evaporation during the heat-treatment process of HEAT THE COMBINATION OF ONE OR MORE FISH BY-PRODUCTS AND CORN STEEP LIQUOR TO CREATE A HEAT-TREATED COMBINATION OF ONE OR MORE FISH BY-PRODUCTS AND CORN STEEP LIQUOR OPERATION 311.

In one embodiment, once at least a portion of the combination of one or more fish by-products and corn steep liquor of COMBINE THE ONE OR MORE FISH BY-PRODUCTS AND THE CORN STEEP LIQUOR TO CREATE A COMBINATION OF ONE OR MORE FISH BY-PRODUCTS AND CORN STEEP LIQUOR OPERATION 307 is heat-treated in the treatment vessel of TRANSFER THE COMBINATION OF ONE OR MORE FISH BY-PRODUCTS AND CORN STEEP LIQUOR INTO A TREATMENT VESSEL OPERATION 309 at HEAT THE COMBINATION OF ONE OR MORE FISH BY-PRODUCTS AND CORN STEEP LIQUOR TO CREATE A HEAT-TREATED COMBINATION OF ONE OR MORE FISH BY-PRODUCTS AND CORN STEEP LIQUOR OPERATION 311 to create a heat-treated combination of one or more fish by-products and corn steep liquor, process flow proceeds to COOL THE HEAT-TREATED COMBINATION OF ONE OR MORE FISH BY-PRODUCTS AND CORN STEEP LIQUOR TO YIELD A FISH BY-PRODUCT BASED ORGANIC FERTILIZER PRODUCT OPERATION 313.

In one embodiment, at COOL THE HEAT-TREATED COMBINATION OF ONE OR MORE FISH BY-PRODUCTS AND CORN STEEP LIQUOR TO YIELD A FISH BY-PRODUCT BASED ORGANIC FERTILIZER PRODUCT OPERATION 313, the heat-treated combination of one or more fish by-products and corn steep liquor of HEAT THE COMBINATION OF ONE OR MORE FISH BY-PRODUCTS AND CORN STEEP LIQUOR TO CREATE A HEAT-TREATED COMBINATION OF ONE OR MORE FISH BY-PRODUCTS AND CORN STEEP LIQUOR OPERATION 311 is allowed to cool in the treatment vessel of TRANSFER THE COMBINATION OF ONE OR MORE FISH BY-PRODUCTS AND CORN STEEP LIQUOR INTO A TREATMENT VESSEL OPERATION 309.

As noted, in one embodiment, the cooling at COOL THE HEAT-TREATED COMBINATION OF ONE OR MORE FISH BY-PRODUCTS AND CORN STEEP LIQUOR TO YIELD A FISH BY-PRODUCT BASED ORGANIC FERTILIZER PRODUCT OPERATION 313 yields the resulting fish by-product based organic fertilizer product.

In one embodiment, once the heat-treated combination of one or more fish by-products and corn steep liquor is cooled at COOL THE HEAT-TREATED COMBINATION OF ONE OR MORE FISH BY-PRODUCTS AND CORN STEEP LIQUOR TO YIELD A FISH BY-PRODUCT BASED ORGANIC FERTILIZER PRODUCT OPERATION 313 to yield the fish by-product based organic fertilizer product, process flow proceeds to EXIT OPERATION 330 and the process for production of a fish by-product based organic fertilizer product from one or more fish by-products and corn steep liquor 300 is exited.

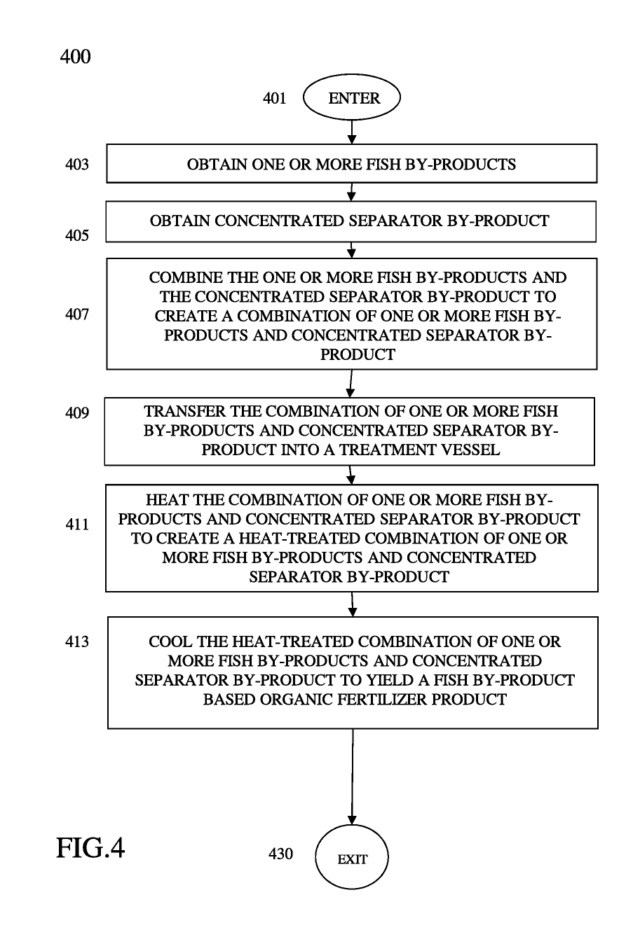

FIG. 4 is a flow chart of a process for creating a fish by-product based organic fertilizer product from one or more fish by-products and concentrated separator by-product, in accordance with one embodiment. As shown in FIG. 4, a process for production of a fish by-product based organic fertilizer product from one or more fish by-products and concentrated separator by-product 400 begins at ENTER OPERATION 401 and process flow proceeds to OBTAIN ONE OR MORE FISH BY-PRODUCTS OPERATION 403.

The one or more fish by-products of OBTAIN ONE OR MORE FISH BY-PRODUCTS OPERATION 403 are, in various embodiments, waste products resulting from fish processing. In one embodiment, once the one or more fish by-products are obtained at OBTAIN ONE OR MORE FISH BY-PRODUCTS OPERATION 403, process flow proceeds to OBTAIN CONCENTRATED SEPARATOR BY-PRODUCT OPERATION 405.

In one embodiment, the concentrated separator by-product of OBTAIN CONCENTRATED SEPARATOR BY-PRODUCT OPERATION 405 is a by-product of the de-sugaring of beet molasses and therefore readily available. Currently, concentrated separator by-product is commonly used as a feed source for livestock.

After concentrated separator by-product is obtained at OBTAIN CONCENTRATED SEPARATOR BY-PRODUCT OPERATION 405, process flow proceeds to COMBINE THE ONE OR MORE FISH BY-PRODUCTS AND THE CONCENTRATED SEPARATOR BY-PRODUCT TO CREATE A COMBINATION OF ONE OR MORE FISH BY-PRODUCTS AND CONCENTRATED SEPARATOR BY-PRODUCT OPERATION 407, in one embodiment. According to one embodiment, at COMBINE THE ONE OR MORE FISH BY-PRODUCTS AND THE CONCENTRATED SEPARATOR BY-PRODUCT TO CREATE A COMBINATION OF ONE OR MORE FISH BY-PRODUCTS AND CONCENTRATED SEPARATOR BY-PRODUCT OPERATION 407, at least a portion of the obtained one or more fish by-products and at least a portion of the obtained concentrated separator by-product are combined.

In one embodiment, the one or more fish by-products is combined with the concentrated separator by-product such that the resulting combination of one or more fish by-products and concentrated separator by-product is 10 percent to 90 percent one or more fish by-products. In one embodiment, the one or more fish by-products is combined with the concentrated separator by-product such that the resulting combination of one or more fish by-products and concentrated separator by-product is 10 percent to 90 percent concentrated separator by-product.

In one embodiment, at COMBINE THE ONE OR MORE FISH BY-PRODUCTS AND THE CONCENTRATED SEPARATOR BY-PRODUCT TO CREATE A COMBINATION OF ONE OR MORE FISH BY-PRODUCTS AND CONCENTRATED SEPARATOR BY-PRODUCT OPERATION 407, at least a portion of the obtained one or more fish by-products and at least a portion of the obtained concentrated separator by-product are combined to yield the one or more fish by-products organic fertilizer product.

In one embodiment, once the obtained one or more fish by-products and the obtained concentrated separator by-product are combined to yield the one or more fish by-products organic fertilizer product at COMBINE THE ONE OR MORE FISH BY-PRODUCTS AND THE CONCENTRATED SEPARATOR BY-PRODUCT TO CREATE A COMBINATION OF ONE OR MORE FISH BY-PRODUCTS AND CONCENTRATED SEPARATOR BY-PRODUCT OPERATION 407, process flow proceeds to EXIT OPERATION 430 and the process for production of a fish by-product based organic fertilizer product from one or more fish by-products and concentrated separator by-product 400 is exited.

In other embodiments, at COMBINE THE ONE OR MORE FISH BY-PRODUCTS AND THE CONCENTRATED SEPARATOR BY-PRODUCT TO CREATE A COMBINATION OF ONE OR MORE FISH BY-PRODUCTS AND CONCENTRATED SEPARATOR BY-PRODUCT OPERATION 407, the one or more fish by-products is combined with the concentrated separator by-product such that the resulting combination of one or more fish by-products and concentrated separator by-product is any desired percentage concentration of one or more fish by-products, typically as determined by cost and the specific needs of the user.

In one embodiment, once the one or more fish by-products and concentrated separator by-product are combined at COMBINE THE ONE OR MORE FISH BY-PRODUCTS AND THE CONCENTRATED SEPARATOR BY-PRODUCT TO CREATE A COMBINATION OF ONE OR MORE FISH BY-PRODUCTS AND CONCENTRATED SEPARATOR BY-PRODUCT OPERATION 407, process flow proceeds to TRANSFER THE COMBINATION OF ONE OR MORE FISH BY-PRODUCTS AND CONCENTRATED SEPARATOR BY-PRODUCT INTO A TREATMENT VESSEL OPERATION 409.

In various embodiments, at TRANSFER THE COMBINATION OF ONE OR MORE FISH BY-PRODUCTS AND CONCENTRATED SEPARATOR BY-PRODUCT INTO A TREATMENT VESSEL OPERATION 409, at least a portion of the combination of one or more fish by-products and concentrated separator by-product is transferred into one or more treatment vessels.

In one embodiment, at TRANSFER THE COMBINATION OF ONE OR MORE FISH BY-PRODUCTS AND CONCENTRATED SEPARATOR BY-PRODUCT INTO A TREATMENT VESSEL OPERATION 409, the combination of one or more fish by-products and concentrated separator by-product is filtered as the combination of one or more fish by-products and concentrated separator by-product is disposed into the treatment vessel. In one embodiment, this filtering is optional. If pre-treatment filtration is desired, a stainless steel, or other suitable material, mesh having a mesh size number between 50 and 200 may be employed. In one embodiment, the mesh size is 200.

In one embodiment, the treatment vessel of TRANSFER THE COMBINATION OF ONE OR MORE FISH BY-PRODUCTS AND CONCENTRATED SEPARATOR BY-PRODUCT INTO A TREATMENT VESSEL OPERATION 409 is an insulated stainless steel tank having electrically powered heat strips applied thereto.

In one embodiment, once at least a portion of the combination of one or more fish by-products and concentrated separator by-product is placed in one or more treatment vessels at TRANSFER THE COMBINATION OF ONE OR MORE FISH BY-PRODUCTS AND CONCENTRATED SEPARATOR BY-PRODUCT INTO A TREATMENT VESSEL OPERATION 409, process flow proceeds to HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411.

In one embodiment, at HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411, at least a portion of the combination of one or more fish by-products and concentrated separator by-product of COMBINE THE ONE OR MORE FISH BY-PRODUCTS AND THE CONCENTRATED SEPARATOR BY-PRODUCT TO CREATE A COMBINATION OF ONE OR MORE FISH BY-PRODUCTS AND CONCENTRATED SEPARATOR BY-PRODUCT OPERATION 407 is mechanically heated.

In one embodiment, at HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411, heat is optionally applied to the combination of one or more fish by-products and concentrated separator by-product to raise the average temperature of the combination of one or more fish by-products and concentrated separator by-product to at least 130 degrees F.

In one embodiment, at HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411, the combination of one or more fish by-products and concentrated separator by-product is maintained in the treatment vessel at or above 130 degrees F. for less than 4 hours. In one embodiment, at HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411, the combination of one or more fish by-products and concentrated separator by-product is maintained in the treatment vessel at or above 130 degrees F. for at least 4 hours. In one embodiment, at HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411, the combination of one or more fish by-products and concentrated separator by-product is maintained in the treatment vessel at or above 130 degrees F. for at least 24 hours to ensure uniform heat transfer to the combination of one or more fish by-products and concentrated separator by-product. In one embodiment, filtration may also be accomplished concurrently at HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411. In one embodiment, the heat-treatment of HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411 may be performed for 120 hours or more, if desired.

In one embodiment, water may be blended with the combination of one or more fish by-products and concentrated separator by-product at HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411 to meet the desired nitrogen per weight or volume requirements of the combination of concentrated separator by-product and one or more fish by-products. In one embodiment, water may also be used to recover losses due to evaporation during the heat-treatment process of HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411.

In one embodiment, once at least a portion of the combination of one or more fish by-products and concentrated separator by-product of COMBINE THE ONE OR MORE FISH BY-PRODUCTS AND THE CONCENTRATED SEPARATOR BY-PRODUCT TO CREATE A COMBINATION OF ONE OR MORE FISH BY-PRODUCTS AND CONCENTRATED SEPARATOR BY-PRODUCT OPERATION 407 is heat-treated in the treatment vessel of TRANSFER THE COMBINATION OF ONE OR MORE FISH BY-PRODUCTS AND CONCENTRATED SEPARATOR BY-PRODUCT INTO A TREATMENT VESSEL OPERATION 409 at HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411 to create a heat-treated combination of one or more fish by-products and concentrated separator by-product, process flow proceeds to COOL THE HEAT-TREATED COMBINATION OF ONE OR MORE FISH BY-PRODUCTS AND CONCENTRATED SEPARATOR BY-PRODUCT TO YIELD A FISH BY-PRODUCT BASED ORGANIC FERTILIZER PRODUCT OPERATION 413.

In one embodiment, at COOL THE HEAT-TREATED COMBINATION OF ONE OR MORE FISH BY-PRODUCTS AND CONCENTRATED SEPARATOR BY-PRODUCT TO YIELD A FISH BY-PRODUCT BASED ORGANIC FERTILIZER PRODUCT OPERATION 413, the heat-treated combination of one or more fish by-products and concentrated separator by-product of HEAT THE COMBINATION OF ONE OR MORE FISH BY-PRODUCTS AND CONCENTRATED SEPARATOR BY-PRODUCT TO CREATE A HEAT-TREATED COMBINATION OF ONE OR MORE FISH BY-PRODUCTS AND CONCENTRATED SEPARATOR BY-PRODUCT OPERATION 411 is allowed to cool in the treatment vessel of TRANSFER THE COMBINATION OF ONE OR MORE FISH BY-PRODUCTS AND CONCENTRATED SEPARATOR BY-PRODUCT INTO A TREATMENT VESSEL OPERATION 409.

As noted, in one embodiment, the cooling at COOL THE HEAT-TREATED COMBINATION OF ONE OR MORE FISH BY-PRODUCTS AND CONCENTRATED SEPARATOR BY-PRODUCT TO YIELD A FISH BY-PRODUCT BASED ORGANIC FERTILIZER PRODUCT OPERATION 413 yields the resulting fish by-product based organic fertilizer product.

In one embodiment, once the heat-treated combination of one or more fish by-products and concentrated separator by-product is cooled at COOL THE HEAT-TREATED COMBINATION OF ONE OR MORE FISH BY-PRODUCTS AND CONCENTRATED SEPARATOR BY-PRODUCT TO YIELD A FISH BY-PRODUCT BASED ORGANIC FERTILIZER PRODUCT OPERATION 413 to yield the fish by-product based organic fertilizer product, process flow proceeds to EXIT OPERATION 430 and the process for production of a fish by-product based organic fertilizer product from one or more fish by-products and concentrated separator by-product 400 is exited.

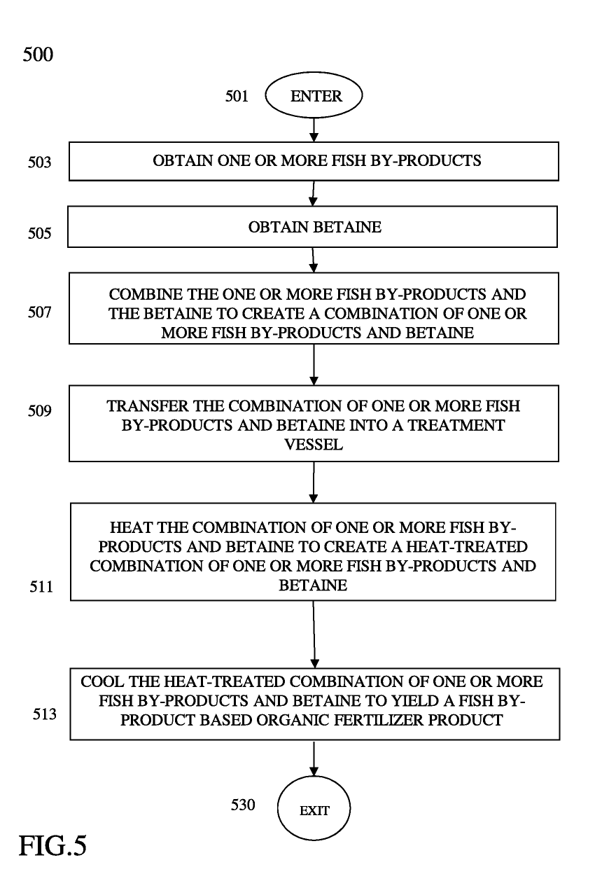

FIG. 5 is a flow chart of a process for creating a fish by-product based organic fertilizer product from one or more fish by-products and betaine, in accordance with one embodiment. As shown in FIG. 5, a process for production of a fish by-product based organic fertilizer product from one or more fish by-products and betaine 500 begins at ENTER OPERATION 501 and process flow proceeds to OBTAIN ONE OR MORE FISH BY-PRODUCTS OPERATION 503.

The one or more fish by-products of OBTAIN ONE OR MORE FISH BY-PRODUCTS OPERATION 503 are, in various embodiments, waste products resulting from fish processing. In one embodiment, once the one or more fish by-products are obtained at OBTAIN ONE OR MORE FISH BY-PRODUCTS OPERATION 503, process flow proceeds to OBTAIN BETAINE OPERATION 505.

In one embodiment, the betaine of OBTAIN BETAINE OPERATION 505 is an N-trimethylated amino acid produced as a by-product of de-sugaring beet molasses. After betaine is obtained at OBTAIN BETAINE OPERATION 505, process flow proceeds to COMBINE THE ONE OR MORE FISH BY-PRODUCTS AND THE BETAINE TO CREATE A COMBINATION OF ONE OR MORE FISH BY-PRODUCTS AND BETAINE OPERATION 507, in one embodiment. According to one embodiment, at COMBINE THE ONE OR MORE FISH BY-PRODUCTS AND THE BETAINE TO CREATE A COMBINATION OF ONE OR MORE FISH BY-PRODUCTS AND BETAINE OPERATION 507, at least a portion of the obtained one or more fish by-products and at least a portion of the obtained betaine are combined.

In one embodiment, the one or more fish by-products is combined with the betaine such that the resulting combination of one or more fish by-products and betaine is 10 percent to 90 percent one or more fish by-products. In one embodiment, the one or more fish by-products are combined with the betaine such that the resulting combination of one or more fish by-products and betaine is 10 percent to 90 percent betaine.

In other embodiments, at COMBINE THE ONE OR MORE FISH BY-PRODUCTS AND THE BETAINE TO CREATE A COMBINATION OF ONE OR MORE FISH BY-PRODUCTS AND BETAINE OPERATION 507, the one or more fish by-products is combined with the betaine such that the resulting combination of one or more fish by-products and betaine is any desired percentage concentration of one or more fish by-products, typically as determined by cost and the specific needs of the user.

In other embodiments, at COMBINE THE ONE OR MORE FISH BY-PRODUCTS AND THE BETAINE TO CREATE A COMBINATION OF ONE OR MORE FISH BY-PRODUCTS AND BETAINE OPERATION 507, the one or more fish by-products is combined with the betaine to yield the fish by-product based organic fertilizer product.

In one embodiment, once the one or more fish by-products is combined with the betaine to yield the fish by-product based organic fertilizer product at COMBINE THE ONE OR MORE FISH BY-PRODUCTS AND THE BETAINE TO CREATE A COMBINATION OF ONE OR MORE FISH BY-PRODUCTS AND BETAINE OPERATION 507, process flow proceeds to EXIT OPERATION 530 and the process for production of a fish by-product based organic fertilizer product from one or more fish by-products and betaine 500 is exited.

In one embodiment, once the one or more fish by-products and betaine are combined at COMBINE THE ONE OR MORE FISH BY-PRODUCTS AND THE BETAINE TO CREATE A COMBINATION OF ONE OR MORE FISH BY-PRODUCTS AND BETAINE OPERATION 507, process flow proceeds to TRANSFER THE COMBINATION OF ONE OR MORE FISH BY-PRODUCTS AND BETAINE INTO A TREATMENT VESSEL OPERATION 509.

In various embodiments, at TRANSFER THE COMBINATION OF ONE OR MORE FISH BY-PRODUCTS AND BETAINE INTO A TREATMENT VESSEL OPERATION 509, at least a portion of the combination of one or more fish by-products and betaine is transferred into one or more treatment vessels.

In one embodiment, at TRANSFER THE COMBINATION OF ONE OR MORE FISH BY-PRODUCTS AND BETAINE INTO A TREATMENT VESSEL OPERATION 509, the combination of one or more fish by-products and betaine is filtered as the combination of one or more fish by-products and betaine is disposed into the treatment vessel. If pre-treatment filtration is desired, a stainless steel, or other suitable material, mesh having a mesh size number between 50 and 200 may be employed. In one embodiment, the mesh size is 200.

In one embodiment, once at least a portion of the combination of one or more fish by-products and betaine is placed in one or more treatment vessels at TRANSFER THE COMBINATION OF ONE OR MORE FISH BY-PRODUCTS AND BETAINE INTO A TREATMENT VESSEL OPERATION 509, process flow proceeds to HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511.

In one embodiment, at HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511, at least a portion of the combination of one or more fish by-products and betaine of COMBINE THE ONE OR MORE FISH BY-PRODUCTS AND THE BETAINE TO CREATE A COMBINATION OF ONE OR MORE FISH BY-PRODUCTS AND BETAINE OPERATION 507 is mechanically heated.

In one embodiment, at HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511, heat is optionally applied to the combination of one or more fish by-products and betaine to raise the average temperature of the combination of one or more fish by-products and betaine to at least 130 degrees F.

In one embodiment, at HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511, the combination of one or more fish by-products and betaine is maintained in the treatment vessel at or above 130 degrees F. for less than 4 hours. In one embodiment, at HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511, the combination of one or more fish by-products and betaine is maintained in the treatment vessel at or above 130 degrees F. for at least 4 hours. In one embodiment, at HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511, the combination of one or more fish by-products and betaine is maintained in the treatment vessel at or above 130 degrees F. for at least 24 hours to ensure uniform heat transfer to the combination of one or more fish by-products and betaine. In one embodiment, filtration may also be accomplished concurrently at HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511. In one embodiment, the heat-treatment of HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511 may be performed for 120 hours or more, if desired.

In one embodiment, water may be blended with the combination of one or more fish by-products and betaine at HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511 to meet the desired nitrogen per weight or volume requirements of the combination of betaine and one or more fish by-products. In one embodiment, water may also be used to recover losses due to evaporation during the heat-treatment process of HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511. Water blending is typically not required, but is rather an optional procedure.

In one embodiment, once at least a portion of the combination of one or more fish by-products and betaine of COMBINE THE ONE OR MORE FISH BY-PRODUCTS AND THE BETAINE TO CREATE A COMBINATION OF ONE OR MORE FISH BY-PRODUCTS AND BETAINE OPERATION 507 is heat-treated in the treatment vessel of TRANSFER THE COMBINATION OF ONE OR MORE FISH BY-PRODUCTS AND BETAINE INTO A TREATMENT VESSEL OPERATION 509 at HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511 to create a heat-treated combination of one or more fish by-products and betaine, process flow proceeds to COOL THE HEAT-TREATED COMBINATION OF ONE OR MORE FISH BY-PRODUCTS AND BETAINE TO YIELD A FISH BY-PRODUCT BASED ORGANIC FERTILIZER PRODUCT OPERATION 513.

In one embodiment, at COOL THE HEAT-TREATED COMBINATION OF ONE OR MORE FISH BY-PRODUCTS AND BETAINE TO YIELD A FISH BY-PRODUCT BASED ORGANIC FERTILIZER PRODUCT OPERATION 513, the heat-treated combination of one or more fish by-products and betaine of HEAT THE COMBINATION OF ONE OR MORE FISH BY-PRODUCTS AND BETAINE TO CREATE A HEAT-TREATED COMBINATION OF ONE OR MORE FISH BY-PRODUCTS AND BETAINE OPERATION 511 is allowed to cool in the treatment vessel of TRANSFER THE COMBINATION OF ONE OR MORE FISH BY-PRODUCTS AND BETAINE INTO A TREATMENT VESSEL OPERATION 509.

As noted, in one embodiment, the cooling at COOL THE HEAT-TREATED COMBINATION OF ONE OR MORE FISH BY-PRODUCTS AND BETAINE TO YIELD A FISH BY-PRODUCT BASED ORGANIC FERTILIZER PRODUCT OPERATION 513 yields the resulting fish by-product based organic fertilizer product.

In one embodiment, once the heat-treated combination of one or more fish by-products and betaine is cooled at COOL THE HEAT-TREATED COMBINATION OF ONE OR MORE FISH BY-PRODUCTS AND BETAINE TO YIELD A FISH BY-PRODUCT BASED ORGANIC FERTILIZER PRODUCT OPERATION 513 to yield the fish by-product based organic fertilizer product, process flow proceeds to EXIT OPERATION 530 and the process for production of a fish by-product based organic fertilizer product from one or more fish by-products and betaine 500 is exited.

Using the processes described above, a fish by-product based organic fertilizer product is provided that is environmentally benign; is non-pathogenic; is derived from natural organic sources; does not require significant processing; has minimal odor; has a low viscosity liquid form; can be applied directly to agricultural vegetation; can be injected and/or added into irrigation streams; includes time-released nitrogen components which become bioavailable to agricultural vegetation by beneficial microbial digestion in soil; and eliminates chemical crop burning.

It should be noted that the language used in the specification has been primarily selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In the discussion above, certain aspects of one embodiment include process steps and/or operations described herein for illustrative purposes in a particular order and/or grouping. However, the particular order and/or grouping shown and discussed herein are illustrative only and not limiting. Those of skill in the art will recognize that other orders and/or grouping of the process steps and/or operations are possible and, in some embodiments, one or more of the process steps and/or operations discussed above can be combined and/or deleted. In addition, portions of one or more of the process steps and/or operations can be re-grouped as portions of one or more other of the process steps and/or operations discussed herein. Consequently, the particular order and/or grouping of the process steps and/or operations discussed herein do not limit the scope of the invention as claimed below.

In addition, the operations shown in the figures are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A process of manufacturing a fish by-product based organic fertilizer product comprising:
obtaining a quantity of one or more fish by-products;
obtaining a quantity of one or more additives; and
combining at least part of the quantity of the one or more fish by-products and at least part of the quantity of the one or more additives.

2. The process of manufacturing the fish by-product based organic fertilizer product of claim 1, wherein combining at least part of the quantity of the one or more fish by-products and at least part of the quantity of the one or more additives yields a combination of the one or more fish by-products and the one or more additives; and further comprising:
heat-treating the combination of the one or more fish by-products and the one or more additives to yield a heat-treated combination of the one or more fish by-products and the one or more additives; and
cooling the heat-treated combination of the one or more fish by-products and the one or more additives to yield the fish by-product based organic fertilizer product.

3. The process of manufacturing the fish by-product based organic fertilizer product of claim 1, wherein the one or more fish by-products is produced from fish and/or fish waste that has been subjected to one or more heating and/or evaporation processes.

4. The process of manufacturing the fish by-product based organic fertilizer product of claim 1, wherein the one or more fish by-products is produced from fish and/or fish waste that has been subjected to one or more enzyme digestion processes.

5. The process of manufacturing the fish by-product based organic fertilizer product of claim 1, wherein one of the one or more additives include one or more grain by-products from the following group of grain by-products:
corn steep liquor,
wet distillers grains,
dried distillers grains with solubles,
fermented grain solubles, and
corn condensed distillers solubles.

6. The process of manufacturing the fish by-product based organic fertilizer product of claim 1, wherein one of the one or more additives is concentrated separator by-product.

7. The process of manufacturing the fish by-product based organic fertilizer product of claim 1, wherein one of the one or more additives is betaine.

8. The process of manufacturing the fish by-product based organic fertilizer product of claim 1, wherein one or more of the one or more additives are selected from the following group of additives:
corn steep liquor;
concentrated separator by-product; and
betaine.

9. The process of manufacturing the fish by-product based organic fertilizer product of claim 1, wherein the fish by-product based organic fertilizer product is 10 percent to 90 percent one or more fish by-products.

10. The process of manufacturing the fish by-product based organic fertilizer product of claim 2, wherein heat-treating the combination of the one or more fish by-products and the one or more additives to yield the heat-treated combination of the one or more fish by-products and the one or more additives comprises heating the combination of the one or more fish by-products and the one or more additives to a range of about 130 to 200 degrees F.

11. The process of manufacturing the fish by-product based organic fertilizer product of claim 1, further comprising:
filtering at least a part of the combination of the one or more fish by-products and the one or more additives using a filter having a standard wire mesh size number in a range of 50 to 200.

12. The process of manufacturing the fish by-product based organic fertilizer product of claim 2, further comprising:
filtering at least a portion of the heat-treated combination of the one or more fish by-products and the one or more additives using a filter having a standard wire size number in a range of 50 to 200.

13. The process of manufacturing the fish by-product based organic fertilizer product of claim 1, wherein the fish by-product based organic fertilizer product includes a nitrogen content in a range of 1 to 10 percent.

14. The process of manufacturing the fish by-product based organic fertilizer product of claim 1, wherein the fish by-product based organic fertilizer product includes a phosphate content in a range of 0.5 to 2.5 percent.

15. The process of manufacturing the fish by-product based organic fertilizer product of claim 1, wherein the fish by-product based organic fertilizer product includes a potassium content in a range of 1 to 7 percent.

16. A fish by-product based organic fertilizer product comprising:
a combination of one or more fish by-products and one or more additives.

17. The fish by-product based organic fertilizer product of claim 16, wherein the combination of one or more fish by-products and one or more additives is subjected to a heat-treating process.

18. The fish by-product based organic fertilizer product of claim 16, wherein the one or more fish by-products is produced from fish and/or fish waste that has been subjected to one or more heating and/or evaporation processes.

19. The fish by-product based organic fertilizer product of claim 16, wherein the one or more fish by-products is produced from fish and/or fish waste that has been subjected to one or more enzyme digestion processes.

20. The fish by-product based organic fertilizer product of claim 16, wherein one of the one or more additives include one or more grain by-products from the following group of grain by-products:
corn steep liquor,
wet distillers grains,
dried distillers grains with solubles,
fermented grain solubles, and
corn condensed distillers solubles.

21. The fish by-product based organic fertilizer product of claim 16, wherein one of the one or more additives is concentrated separator by-product.

22. The fish by-product based organic fertilizer product of claim 16, wherein one of the one or more additives is betaine.

23. The fish by-product based organic fertilizer product of claim 16, wherein one or more of the one or more additives are selected from the following group of additives:
corn steep liquor;
concentrated separator by-product; and
betaine.

24. The fish by-product based organic fertilizer product of claim 16, wherein the fish by-product based organic fertilizer product is 10 percent to 90 percent one or more fish by-products.

25. The fish by-product based organic fertilizer product of claim 17, wherein the combination of the one or more fish by-products and the one or more additives is heat-treated to a range of about 130 to 200 degrees F.

26. The fish by-product based organic fertilizer product of claim 16, wherein the combination of the one or more fish by-products and the one or more additives includes a nitrogen content in a range of 1 to 10 percent.

27. The fish by-product based organic fertilizer product of claim 16, wherein the combination of the one or more fish by-products and the one or more additives includes a phosphate content in a range of 0.5 to 2.5 percent.

28. The fish by-product based organic fertilizer product of claim 16, wherein the combination of the one or more fish by-products and the one or more additives includes a potassium content in a range of 1 to 7 percent.

29. A process for fertilization comprising:
obtaining a quantity of fish by-product based organic fertilizer product, wherein the fish by-product based organic fertilizer product is a combination of one or more fish by-products and one or more additives; and
applying the fish by-product based organic fertilizer product to the agricultural vegetation.

30. The process for fertilization of claim 29, wherein the combination of one or more fish by-products and one or more additives is subjected to a heat-treating process.

31. The process for fertilization of claim 29, wherein the one or more fish by-products is produced from fish and/or fish waste that has been subjected to one or more heating and/or evaporation processes.

32. The process for fertilization of claim 29, wherein the one or more fish by-products is produced from fish and/or fish waste that has been subjected to one or more enzyme digestion processes.

33. The process for fertilization of claim 29, wherein one of the one or more additives include one or more grain by-products from the following group of grain by-products:
corn steep liquor,
wet distillers grains,
dried distillers grains with solubles,
fermented grain solubles, and
corn condensed distillers solubles.

34. The process for fertilization of claim 29, wherein one of the one or more additives is concentrated separator by-product.

35. The process for fertilization of claim 29, wherein one of the one or more additives is betaine.

36. The process for fertilization of claim 29, wherein one or more of the one or more additives are selected from the following group of additives:
corn steep liquor;
concentrated separator by-product; and
betaine.

37. The process for fertilization of claim 29, wherein the fish by-product based organic fertilizer product is 10 percent to 90 percent one or more fish by-products.

38. The process for fertilization of claim 29, wherein the combination of the fish by-product based organic fertilizer product includes a nitrogen content in a range of 1 to 10 percent.

39. The process for fertilization of claim 29, wherein the fish by-product based organic fertilizer product includes a phosphate content in a range of 0.5 to 2.5 percent.

40. The process for fertilization of claim 29, wherein the fish by-product based organic fertilizer product includes a potassium content in a range of 1 to 7 percent.

41. The process for fertilization of claim 29, wherein applying the fish by-product based organic fertilizer product to the agricultural vegetation comprises applying the fish by-product based organic fertilizer product at a rate of 5 to 900 gallons per acre.

42. The process for fertilization of claim 29, wherein applying the fish by-product based organic fertilizer product to the agricultural vegetation comprises applying/adding the fish by-product based organic fertilizer product directly to the agricultural vegetation and/or fields and/or soil and/or substrate supporting the agricultural vegetation.

43. The process for fertilization of claim 29, wherein applying the fish by-product based organic fertilizer product to the agricultural vegetation comprises applying/adding the fish by-product based organic fertilizer product to an irrigation system servicing the agricultural vegetation.

44. The process for fertilization of claim 29, wherein applying the fish by-product based organic fertilizer product to the agricultural vegetation comprises adding the fish by-product based organic fertilizer product to a liquid base to obtain a desired concentration of fish by-product based organic fertilizer product.

45. The process for fertilization of claim 44 wherein the desired concentration of fish by-product based organic fertilizer product is 10 percent to 90 percent.
